(19) United States
(12) Patent Application Publication
(10) Pub. No.: US 2010/0149076 A1
(43) Pub. Date: Jun. 17, 2010

(54) COMPOSITION FOR PREPARING PHOSPHOR LAYER, PLASMA DISPLAY PANEL AND METHOD OF MANUFACTURING THE PLASMA DISPLAY PANEL

(75) Inventor: Young-Gil YOO, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/626,702

(22) Filed: Nov. 27, 2009

(30) Foreign Application Priority Data
Dec. 17, 2008 (KR) 10-2008-0128613

(51) Int. Cl. G09G 3/28; C09K 11/65; B05D 5/06

(52) U.S. Cl. 345/60; 252/301.4 R; 427/162

(57) ABSTRACT

A composition for preparing a phosphor layer includes a phosphor, a binder, a solvent and an active carbon component. A plasma display panel includes the phosphor layer. The phosphor layer of the plasma display panel is formed by depositing the composition for preparing the phosphor layer and heat treating the deposited composition.

### CROSS-REFERENCE TO RELATED PATENT APPLICATION

This application claims the benefit of Korean Patent Application No. 10-2008-0128613, filed on Dec. 17, 2008 in the Korean Intellectual Property Office, the disclosure of which is incorporated herein by reference.

### BACKGROUND OF THE INVENTION

1. Field of the Invention

Aspects of the present invention relate to a composition for preparing a phosphor layer, a plasma display panel, and a method of manufacturing the plasma display panel.

2. Description of the Related Art

Display devices can be categorized into self emission type display devices that emit light by themselves and non-self emission type display devices that use a separate lamp. Examples of non-self emission type display devices include liquid crystal display devices (LCDs). Examples of self emission type display devices include plasma display panels (PDPs), cathode ray tubes (CRTs), and organic light emitting display devices (OLEDs).

Self emission type display devices typically use phosphors to emit light. Phosphors can be generally categorized into photoluminescent (PL) phosphors, cathodoluminescent (CL) phosphors, and electroluminescent (EL) phosphors. PDPs, which have recently received much attention as self emission type display devices, use PL phosphors. In particular, phosphors may be included in a phosphor layer in a plasma display panel. The phosphor layer may be formed by preparing a composition for the phosphor layer, supplying the prepared composition to a predetermined region, and heat-treating the prepared composition.

### SUMMARY OF THE INVENTION

Aspects of the present invention may prevent phosphor deterioration due to high temperature when a composition for preparing a phosphor layer is heat treated.

According to an aspect of the present invention, there is provided a composition for preparing a phosphor layer, wherein the composition includes a phosphor, a binder, a solvent, and an active carbon component.

According to another aspect of the present invention, there is provided a phosphor layer of a plasma display panel, the phosphor layer including a phosphor; and a heat treatment product of an active carbon component.

According to another aspect of the present invention, there is provided a plasma display panel including: a first substrate and a second substrate facing the first substrate; a phosphor layer disposed in a discharge space between the first substrate and the second substrate; a discharge electrode that applies a voltage to the discharge space so as to generate a discharge; and a discharge gas loaded in the discharge space, wherein the phosphor layer includes a phosphor and a heat treatment product of an active carbon component.

According to another aspect of the present invention, there is provided a method of forming a phosphor layer on a surface, the method including applying the composition as described above to the surface; and heat treating the applied composition to form the phosphor layer.

According to another aspect of the present invention, there is provided a method of manufacturing a plasma display panel, wherein the method includes: preparing the composition as described above; supplying the composition to a discharge space between a first substrate and a second substrate; and heat treating the supplied composition to form a phosphor layer in the discharge space.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawing:

FIG. 1 is a schematic perspective view of a plasma display panel according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A composition for preparing a phosphor layer according to an embodiment of the present invention includes a phosphor, a binder, a solvent, and an active carbon component.

The phosphor may be a conventionally available phosphor that can be included in a phosphor layer of a plasma display panel, such as, for example, a red (R), green (G), or blue (B) phosphor. For example, the phosphor may be a material that is relatively unstable at high temperature, such as a green phosphor and/or blue phosphor having a center wavelength of about 530 nm, and/or a blue phosphor having a center wavelength in a range from 430 nm to 470 nm (such as, for example, a BAM-based blue phosphor or a CMS-based blue phosphor).

The average diameter of the phosphor may be in a range from 0.5 μm to 5.0 μm, for example, or, as a more particular non-limiting example, from 1.6 μm to 2.8 μm. If the average diameter of the phosphor is 0.5 μm or more, excellent luminescent properties can be obtained. On the other hand, if the average diameter of the phosphor is 5.0 μm or less, nozzle clogging can be prevented when a composition for preparing a phosphor layer is supplied, and a flat phosphor layer surface can be substantially obtained.

As non-limiting examples, the red phosphor may include at least one phosphor selected from the group consisting of a Y(V,P)O₄:Eu phosphor, a Y₂O₃:Eu phosphor, and a (Y,Gd)BO₃:Eu phosphor. However, the red phosphor is not limited to these examples. As non-limiting examples, the green phosphor may include at least one phosphor selected from the group consisting of a LaPO₄:Ce,Tb phosphor, a ZnGa₂O₄:Mn phosphor, a ReBO₃:Tb phosphor where Re denotes at least one of rare-earth based element, a Zn₂SiO₄:Mn phosphor, and a BaMgAl₁₀O₁₇:Eu,Mn phosphor. However, the green phosphor is not limited to these examples. As non-limiting examples, the blue phosphor may include at least one phosphor selected from the group consisting of a BaMgAl₁₀O₁₇:Eu phosphor, a BaMgAl₁₄O₂₃:Eu phosphor, a BaMg₂Al₁₆O₂₇:Eu phosphor, and a CaMgSi₂O₆:Eu phosphor. However, the blue phosphor is not limited to these examples.

The binder provides a desired level of viscosity to the composition, and when the composition is supplied to a predetermined region, the composition encircles the phosphor to form a flat film. As non-limiting examples, the binder may include at least one resin selected from the group consisting of a cellulose-based resin and an acryl-based resin.

The cellulose-based resin may be, for example, methyl cellulose, ethyl cellulose, propyl cellulose, hydroxy methyl cellulose, hydroxy ethyl cellulose, hydroxy propyl cellulose, hydroxy ethyl propyl cellulose, or a mixture thereof, but is not limited thereto. The acryl-based resin may be, for example, poly methyl methacrylate; poly isopropyl methacrylate; poly isobutyl methacrylate; polymers (for example, a homopolymer or copolymer etc.) of an acryl-based monomer such as methyl meth acrylate, ethyl meth acrylate, propyl meth acrylate, butyl meth acrylate, hexyl meth acrylate, 2-ethyl hexyl meth acrylate, benzyl meth acrylate, dimethyl amino ethyl meth acrylate, hydroxy ethyl meth acrylate, hydroxy propyl meth acrylate, hydroxy butyl meth acrylate, phenoxy 2-hydroxy propyl meth acrylate, glycidyl meth acrylate, methyl acrylate, ethyl acrylate, propyl acrylate, butyl acrylate, hexyl acrylate, 2-ethyl hexyl acrylate, benzyl acrylate, dimethyl amino ethyl acrylate, hydroxy ethyl acrylate, hydroxy propyl acrylate, hydroxy butyl acrylate, phenoxy 2-hydroxy propyl acrylate, or glycidyl acrylate; or a mixture thereof, but is not limited thereto.

The amount of the binder may be in a range from about 5 parts by weight to about 25 parts by weight, for example, or as a more specific non-limiting example, from about 7 parts by weight to about 20 parts by weight, based on 100 parts by weight of the phosphor. If the amount of the binder is 5 or more parts by weight based on 100 parts by weight of the phosphor, a level of viscosity that is appropriate for printing can be obtained. On the other hand, if the amount of the binder is 25 or lower parts by weight based on 100 parts by weight of the phosphor, the presence of a residual carbon derived from the binder may be avoided.

The solvent may provide an appropriate flowability to the composition, disperse the phosphor, and dissolve the binder. For example, the solvent may include at least one solvent selected from the group consisting of butyl cellosolve (BC), terpineol, butyl carbitol, butyl carbitol acetate, pentanediol, dipentene, limonene, and distilled water. However, the solvent is not limited to these solvents.

The amount of the solvent may be in a range from about 90 parts by weight to about 250 parts by weight, for example, or as a more particular non limiting example, from about 100 parts by weight to about 230 parts by weight, based on 100 parts by weight of the phosphor. If the amount of the solvent is 90 or more parts by weight based on 100 parts by weight of the phosphor, dispersibility of the composition may be maintained. On the other hand, if the amount of the solvent is 250 or less parts by weight based on 100 parts by weight of the phosphor, the viscosity of the composition may be appropriate for forming the phosphor layer.

The active carbon component reduces the phosphor when the composition is heat treated, and prevents deterioration of the phosphor. The active carbon component may include an active carbon and an additional component.

As used in the present specification, the term “active carbon” indicates a carbon-based material formed of an amorphous carbon. The term “additional component” indicates various components that may necessarily co-exist with the “active carbon.” That is, the term “additional component” may refer to other components excluding the “active carbon” in the “active carbon component.” For example, the additional component may be one or more of various components (such as, for example, silicon, aluminum, iron, silica, alumina, iron oxide, or chloride) derived from impurities in a source material for preparing the active carbon. The source material may be, for example, wood, sawdust, coconut bark, lignin, lignite, brown coal, peat, or activated coal. The additional component may vary according to a source material that is used for manufacturing or synthesizing the active carbon, or according to a manufacturing or synthesizing process that is used. Additional components corresponding to various active carbons may be readily ascertained by people skilled in the art. The term “active carbon component” indicates a combination of the “active carbon” and the “additional component.”

As described more fully herein, a reduction of the phosphor during a heat treatment process of the composition may be substantially performed by the active carbon of the active carbon component.

The active carbon of the active carbon component may have various shapes. For example, the active carbon may have the shape of a spherical particle, an amorphous particle, a porous particle, a fiber, a horn, or a plate, but the shape of the active carbon is not limited thereto. The active carbon may be a carbon particle, a carbon nanotube, a carbon nanohorn, or a fullerene, but is not limited thereto. If the active carbon has the shape of a spherical particle, the average diameter of the spherical particle may be in a range from about 1 μm to about 20 μm, for example, or as a more specific, non-limiting example, from about 1 μm to about 10 μm.

The additional component of the active carbon component may be metal, metal oxide, metal chloride, or a halogen element. For example, the additional component may include at least one material selected from the group consisting of silicon, aluminum, iron, silica, alumina, Fe₂O₃, AlCl₃, FeCl₃ and Cl, but is not limited thereto.

The amount of the additional component may be in a range from about 0.1 parts by weight to about 5 parts by weight, for example, or more as a more specific, non-limiting example, from about 0.1 parts by weight to about 3 parts by weight based on 100 parts by weight of the active carbon component. If the amount of the additional component is less than 0.1 parts by weight based on 100 parts by weight of the active carbon component, it may be necessary to refine the active carbon for a long period time to bring the amount of a naturally occurring additional component to this level, thereby increasing expenses. On the other hand, if the amount of the additional component is more than 5 parts by weight based on 100 parts by weight of the active carbon component, the amount of the active carbon is relatively low and thus, deterioration of the phosphor during the heat treatment process of the composition may not be effectively prevented.

The amount of the active carbon component may be in a range from about 10 parts by weight to about 20 parts by weight, for example, about 13 parts by weight to about 16 parts by weight, based on 100 parts by weight of the composition. If the amount of the active carbon component is less than 10 parts by weight based on 100 parts by weight of the composition, when the composition is heat treated, deterioration of the phosphor may not be efficiently prevented. On the other hand, if the amount of the active carbon component is more than 20 parts by weight based on 100 parts by weight of the composition, the active carbon component may remain as a residual carbon after the composition is heat treated. In this case, a discharge efficiency of a plasma display panel manufactured using the active carbon component may be reduced.

In addition to the phosphor, binder, solvent, and active carbon component as described above, the composition may further include a photosensitizer such as benzophenone, an anti-forming agent, a dispersing agent, a plasticizer, a leveling agent, or an anti-oxidant. The anti-forming agent or dispersing agent may be a silicon polyester resin, but is not limited thereto. The plasticizer may be a phthalate-based compound, such as dioctyl phthalate 2-ethylhexyl phthalate, diisononyl phthalate, dibutyl phthalate, or diisodecyl phthalate, but is not limited thereto.

A method of manufacturing a plasma display panel according to an embodiment of the present invention may include: preparing the composition as described above; supplying the composition to a discharge space between a first substrate and a second substrate; and heat treating the supplied composition to form a phosphor layer in the discharge space.

First, the composition for preparing a phosphor layer, the composition including a phosphor, a binder, a solvent and an active carbon component as described above, is prepared. The viscosity of the composition may be in a range from about 15000 cps to about 23000 cps, for example, or as a more specific non-limiting example, from about 7000 cps to about 21000 cps. If the viscosity of the composition is in this range, printability of the composition supplied can be improved and a phosphor layer having a precise pattern can be formed.

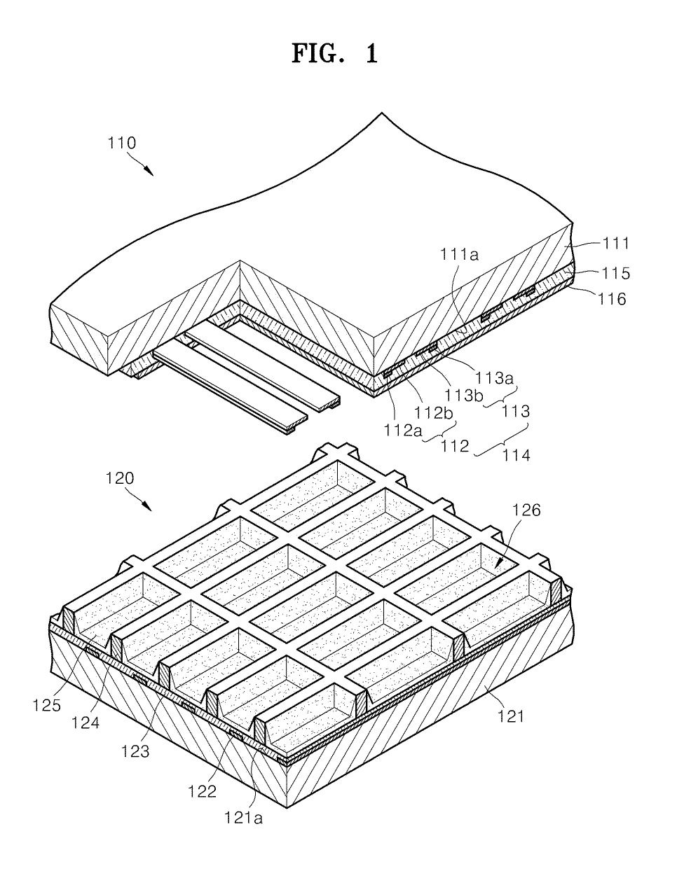

Then, the composition is supplied to a predetermined region of the discharge space between the first substrate and the second substrate. Herein, the “first substrate,” the “second substrate” and the “discharge space” indicate two substrates of a plasma display panel and a discharge space formed between the substrates, as can be easily understood by referring to FIG. 1 and the following description with reference to FIG. 1. The “predetermined region of the discharge space between the first substrate and the second substrate” indicates a region in which the phosphor layer is to be formed, as described below with respect to FIG. 1.

The method of supplying the composition may be any known methods. For example, the supplying method may be performed using a dispenser apparatus or may be an inkjet printing method. However, the supplying method is not limited to the methods as described above. Also, the composition may be supplied in various modified ways. For example, the composition may be supplied in R, G and B patterns according to the phosphor included therein, that is, according to which color light is emitted by the phosphor among red light, green light and blue light.

The composition supplied to the predetermined region of the discharge space is heat treated to form the phosphor layer in the discharge space between the first substrate and the second substrate. The heat treatment condition may be an atmospheric condition. As used herein, the term “atmospheric condition” refers a condition of being in the presence of air and at atmospheric pressure. The heat treatment temperature may be in a range from about 400° C. to about 600° C., for example, or as a more specific, non-limiting example, from about 480° C. to about 550° C. The heat treatment time may be in a range from about 30 minutes to about 4 hours. The heat treatment process may be altered in various ways. For example, before the heat treatment, the composition for forming the phosphor layer may be dried in advance at a temperature in a range from 150° C. to 220° C. to remove a portion of the solvent.

Inclusion of the active carbon component in the composition may contribute to prevention of phosphor deterioration even when the heat treatment process is performed at a high temperature for a short period of time. For example, if the composition is heat treated at a temperature of about 500° C. for 1 hour to form the phosphor layer, the composition can also be heat treated at a temperature of 550° C. for 30 minutes. In the latter case, the heat treatment is performed at a relatively high temperature and thus, less residual carbon may be formed and the manufacturing costs and time may be reduced and productivity in manufacturing the plasma display panel may be increased.

A plasma display panel according to an embodiment of the present invention includes: a first substrate and a second substrate facing the first substrate; a phosphor layer disposed in a discharge space between the first substrate and the second substrate; a discharge electrode that applies a voltage to the discharge space so as to generate a discharge; and a discharge gas loaded to the discharge space, wherein the phosphor layer includes a phosphor and a heat treatment product of an active carbon component. The detailed descriptions of the phosphor and active carbon component have been presented above.

For example, the heat treatment product of an active carbon component may be a product obtained by heat treating the active carbon component under an atmospheric condition at a temperature in a range from about 400° C. to about 600° C. This temperature range may be similar to the heat treatment temperature range in the method of manufacturing a plasma display panel.

As described above, the active carbon component includes an active carbon and an additional component. Since the active carbon is a carbon-based material, when the active carbon is heat treated under an atmospheric condition at a temperature in a range from about 400° C. to about 600° C., the active carbon is substantially removed. That is, the active carbon is reacted with O₂ to form CO₂. Accordingly, the heat treatment product of the active carbon component may be a material derived from the additional component included in the active carbon component. For example, the heat treatment product of the active carbon component may be a material among additional components included in the active carbon component that does not burn under an atmospheric condition at a temperature in a range from about 400° C. to about 600° C., or a material that is derived from the additional component by the heat treatment (for example, if the additional component is metal, the metal may be formed into metal oxide by the heat treatment).

Specifically, the heat treatment product of the active carbon component may include at least one material selected from the group consisting of metal oxides and metal chlorides. More specifically, the heat treatment product of the active carbon component may include at least one material selected from the group consisting of silica, alumina, Fe₂O₃, iron chloride (FeCl₃) and aluminum chloride (AlCl₃). However, the heat treatment product of the active carbon component is not limited to the materials as described above.

The amount of the heat treatment product of the active carbon component in the phosphor layer may be in a range from about 0.5 parts by weight to about 15 parts by weight, for example, or as a more specific, non-limiting example, from about 2 parts by weight to about 12 parts by weight, based on 100 parts by weight of the phosphor. The amount of the heat treatment product of the active carbon component may vary according to the amount of the active carbon component used and the amount of the additional component included in the active carbon.

The phosphor layer may be formed by heat treating the composition including the phosphor, the binder, the solvent, and the active carbon component. For example, the phosphor layer may be formed by heat treating the composition under an atmospheric condition at a temperature in a range from about 400° C. to about 600° C.

FIG. 1 is a schematic perspective view of a plasma display panel according to an embodiment of the present invention. Referring to FIG. 1, the plasma display panel includes a first panel 110 and a second panel 120. The first panel 110 includes a first substrate 111, pairs of sustain electrodes 114 formed on a bottom surface 111a of the first substrate 111 wherein each pair of sustain electrodes 114 includes an Y electrode 112 and an X electrode 113, a first dielectric layer 115 covering the pairs of sustain electrodes 114, and a protection layer 116 covering the first dielectric layer 115. Each Y electrode 112 includes a transparent electrode 112b and a bus electrode 112a. Each X electrode includes a transparent electrode 113b and a bus electrode 113a. As a non-limiting example, the transparent electrodes 112b and 113b may be formed of indium tin oxide (ITO). The bus electrodes 112a and 113a may be formed of metal having good conductivity.

The second panel 120 includes a second substrate 121, address electrodes 122 that extend in a direction that crosses the pairs of sustain electrodes 114 and are formed over an entire surface 121a of the second substrate 121, a second dielectric layer 123 covering the address electrodes 122, and barrier ribs 124 disposed on the second dielectric layer 123.

When the first panel 110 is coupled to the second panel 120, a lower portion of the barrier ribs 124 contacts the second dielectric layer 123 and an upper portion of the barrier ribs 124 contacts the first dielectric layer 115 (or the protection layer 116 covering the first dielectric layer 115). Accordingly, the barrier ribs 124 divide a discharge space between the first substrate 111 and the second substrate 121, thereby forming a plurality of discharge cells 126. In the embodiment shown in FIG. 1, the barrier ribs 124 are arranged in a matrix pattern and thus, the discharge cells 126 are rectangular. However, it is to be understood that the barrier ribs 124 may be arranged in patterns other than what is shown and that the discharge cells 126 may therefore have other shapes.

Herein, the term “discharge electrode that applies a voltage to the discharge space so as to generate a discharge” may refer collectively to all of the pairs of sustain electrodes 114 and the address electrodes 122.

A phosphor layer 125 may be formed in the discharge cells 126. For example, the phosphor layer 125 may be formed on surface boundaries of the discharge cells 126, such as surfaces of the barrier ribs 124 and surfaces of the dielectric layer 123 between the barrier ribs 124. The phosphor layer 125 includes the phosphor and the heat treatment product of the active carbon component as described in detail above. The phosphor included in the phosphor layer 125 may not be substantially deteriorated even in the heat treatment process that is performed to form the phosphor layer and thus, the plasma display panel including the phosphor layer 125 may have a long lifetime.

The discharge cells 126 may be charged with a discharge gas. The discharge gas may be a Ne—Xe mixed gas including 5% to 10% of Xe. If desired, at least a portion of Ne may be replaced with He.

Although the plasma display panel has been described with reference to FIG. 1, the structure of the plasma display panel is not limited to that illustrated in FIG. 1 and can be modified in various ways.

Aspects of the present invention will now be described in further detail with reference to the following examples. These examples are for illustrative purposes only and are not intended to limit the scope of the present invention.

### Example 1

100 parts by weight of a Zn₂SiO₄:Mn green phosphor, 15 parts by weight of a binder based on 100 parts by weight of the Zn₂SiO₄:Mn green phosphor, 150 parts by weight of a solvent based on 100 parts by weight of the Zn₂SiO₄:Mn green phosphor, and 5 parts by weight of an active carbon component based on 100 parts by weight of the Zn₂SiO₄:Mn green phosphor were mixed and the mixture was stirred using a paste stirrer, thereby preparing a composition for preparing a green phosphor layer having a viscosity in a range from 19000 cps to 21000 cps. The binder was ethyl cellulose available from Dow Chemical Co., the solvent was a mixture including terpineol and butyl carbitol acetate in a volume ratio of 7:3, and the active carbon component was a commercially available active carbon component manufactured by Handokcarbon Co., Ltd. The active carbon component included a spherical carbon particle having an average particle diameter of 7 μm that constitutes an active carbon. 0.15 wt. % of Fe₂O₃ (based on 100 wt. % of the active carbon component) and 0.25 wt. % of CI (based on 100 wt. % of the active carbon component) constituted an additional component.

A composition for preparing a blue phosphor layer was prepared in the same manner as in the preparation method as described above, except that a BaMgAl₁₀O₁₇:Eu blue phosphor was used instead of the Zn₂SiO₄:Mn green phosphor.

Address electrodes made of copper were formed by photolithography on a glass substrate having a thickness of 2 mm. PbO glass was coated onto the address electrodes to form a second dielectric layer having a thickness of 20 μm. Then, the composition for preparing a green phosphor layer and the composition for preparing a blue phosphor layer were respectively ejected into a green discharge cell and a blue discharge cell using a dispenser device. The ejection pressure was controlled so that the compositions were respectively deposited to a height of about 100 μm on the second dielectric layer. The coated compositions were dried at a temperature of 100° C. for 15 minutes, and then the temperature was ramped upwards. The coated compositions were left to sit for 15 minutes whenever the temperature was increased by 50° C. When the temperature reached 500° C., the coated compositions were heat treated for one and a half hours, and thus, a green phosphor layer and a blue phosphor layer were formed, thereby completing the manufacture of a second substrate.

Then, a bus electrode was formed of copper on a glass substrate having a thickness of 2 mm by photolithography. PbO glass was coated onto the bus electrode to form a first dielectric layer having a thickness of 20 μm. Then, a MgO protection layer was formed on the first dielectric layer, thereby completing the manufacture of a first substrate.

The second substrate and the first substrate were arranged to be in parallel at an interval of 130 μm, thereby forming cells, and a mixed gas including 36% of Ne, 13% of Xe, and 51% of He as a discharge gas was injected into the cells, thereby producing a plasma display panel.

The amounts of Fe₂O₃ and metal chloride in each of the green phosphor layer and the blue phosphor layer were measured using EDS (Hitachi Co. “S-4800”) and ICP (Horiba Co. Jobin Yvon “ULTIMA2C”) apparatuses. As a result, it was determined that the green phosphor layer and the blue phosphor layer each included 0.75 parts by weight of Fe₂O₃ and 1.25 parts by weight of metal chloride, based on 100 parts by weight of the corresponding phosphor layer.

### Example 2

A plasma display panel was manufactured in the same manner as in Example 1, except that 10 parts by weight of the active carbon component based on 100 parts by weight of the composition for preparing a green phosphor layer and 10 parts by weight of the active carbon component based on 100 parts by weight of the composition for preparing a blue phosphor layer were used.

The amounts of Fe₂O₃ and metal chloride in each of the green phosphor layer and the blue phosphor layer were measured using the same method as used in Example 1. As a result, it was determined that the green phosphor layer and the blue phosphor layer each included 1.50 parts by weight of Fe₂O₃ and 2.50 parts by weight of metal chloride, based on 100 parts by weight of the corresponding phosphor layer.

### Example 3

A plasma display panel was manufactured in the same manner as in Example 1, except that 15 parts by weight of the active carbon component based on 100 parts by weight of the composition for preparing a green phosphor layer and 15 parts by weight of the active carbon component based on 100 parts by weight of the composition for preparing a blue phosphor layer were used.

The amounts of Fe₂O₃ and metal chloride in each of the green phosphor layer and the blue phosphor layer were measured using the same method as used in Example 1. As a result, it was determined that the green phosphor layer and the blue phosphor layer each included 2.25 parts by weight of Fe₂O₃ and 3.75 parts by weight of metal chloride, based on 100 parts by weight of the corresponding phosphor layer.

### Example 4

A plasma display panel was manufactured in the same manner as in Example 1, except that 20 parts by weight of the active carbon component based on 100 parts by weight of the composition for preparing a green phosphor layer and 20 parts by weight of the active carbon component based on 100 parts by weight of the composition for preparing a blue phosphor layer were used.

The amounts of Fe₂O₃ and metal chloride in each of the green phosphor layer and the blue phosphor layer were measured using the same apparatuses as used in Example 1. As a result, it was determined that the green phosphor layer and the blue phosphor layer each included 3.00 parts by weight of Fe₂O₃ and 5.00 parts by weight of metal chloride, based on 100 parts by weight of the corresponding phosphor layer.

### Example 5

A plasma display panel was manufactured in the same manner as in Example 1, except that 30 parts by weight of the active carbon component based on 100 parts by weight of the composition for preparing a green layer and 30 parts by weight of the active carbon component based on 100 parts by weight of the composition for a blue phosphor layer were used.

The amounts of Fe₂O₃ and metal chloride in each of the green phosphor layer and the blue phosphor layer were measured using the same apparatuses as used in Example 1. As a result, it was determined that the green phosphor layer and the blue phosphor layer each included 4.50 parts by weight of Fe₂O₃ and 7.50 parts by weight of metal chloride, based on 100 parts by weight of the corresponding phosphor layer.

### Comparative Example

A plasma display panel was manufactured in the same manner as in Example 1, except that the active carbon component was not used.

### Evaluation Example

Lifetime characteristics, such as, for example, a luminance maintenance rate of the plasma display panels manufactured according to the Comparative Example and Examples 1 to 5, were measured. First, the initial luminance of the plasma display panel manufactured according to Comparative Example with respect to green emission and blue emission was evaluated using a Kr-lamp spectrometer in a Darsa system including a 10⁻⁵ torr vacuum chamber. Then, the plasma display panel manufactured according to the Comparative Example was subjected to 1% window white accelerated aging (@500 cd) for 500 hours and luminance with respect to green emission and blue emission was evaluated. By using initial luminance and after-aging luminance, a luminance maintenance rate was measured with respect to each of green emission and blue emission. The same experiment was performed using each of the plasma display panels manufactured according to Examples 1 through 5. The results are shown in Table 1.

TABLE 1

| | Amount of active | Amount of | Amount of | Luminescence | Luminescence |
|---|---|---|---|---|---|
| | carbon | Fe₂O₃ in | metal chloride | maintenance | maintenance |
| | component in the | phosphor layer² | in phosphor | rate of green | rate of blue |
| | composition¹ | (parts by | layer³ (parts by | phosphor layer⁴ | phosphor layer⁵ |
| Example No. | (parts by weight) | weight) | weight) | (%) | (%) |
| Comparative | 0 | 0 | 0 | 82.6 | 77.5 |
| Example | | | | | |
| Example 1 | 5 | 0.75 | 1.25 | 85.4 | 80.2 |
| Example 2 | 10 | 1.50 | 2.50 | 89.7 | 87.0 |
| Example 3 | 15 | 2.25 | 3.75 | 95.0 | 93.3 |
| Example 4 | 20 | 3.00 | 5.00 | 91.3 | 86.8 |
| Example 5 | 30 | 4.50 | 7.50 | 84.2 | 78.4 |

¹The active carbon component is used in both the composition for preparing a green phosphor layer and the composition for preparing a blue phosphor layer, and the amount of the active carbon component is based on 100 parts by weight of the corresponding composition (parts by weight).
^{2, 3}Fe₂O₃ is included in both the composition for preparing a green phosphor layer and the composition for preparing a blue phosphor layer, and the amount of Fe₂O₃ is based on 100 parts by weight of the corresponding composition (parts by weight).
^{4, 5}The luminance maintenance rates with respect to respective phosphor layers were measured by luminance after 500-hour aging/initial luminance × 100(%).

According to Table 1, it can be seen that the plasma display panels manufactured according to Examples 1 to 5 have a higher luminance maintenance rate than the plasma display panel manufactured according to the Comparative Example.

A composition for preparing a phosphor layer according to the embodiments of the present invention includes an active carbon component and thus, phosphor deterioration occurring in a heat treatment process of the composition can be prevented. Accordingly, a plasma display panel including a phosphor layer that includes a phosphor and a heat treatment product of the active carbon component can have excellent characteristics.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A composition for preparing a phosphor layer, the composition comprising:
a phosphor;
a binder;
a solvent; and
an active carbon component.

2. The composition of claim 1, wherein the active carbon component comprises an active carbon and an additional component.

3. The composition of claim 2, wherein the active carbon has the shape of spherical particles, amorphous particles, porous particles, fibers, horns, or plates.

4. The composition of claim 2, wherein the additional component comprises at least one material selected from the group consisting of silicon, aluminum, iron, silica, alumina, Fe₂O₃, FeCl₃, AlCl₃ and chloride (Cl).

5. The composition of claim 1, wherein the amount of the active carbon component is in a range of from 10 parts by weight to 20 parts by weight based on 100 parts by weight of the composition.

6. The composition of claim 1, wherein the phosphor comprises at least one phosphor selected from the group consisting of a green phosphor having a central wavelength of about 530 nm and a blue phosphor having a central wavelength in a range of from 430 nm to 470 nm.

7. A phosphor layer of a plasma display panel, the phosphor layer comprising:
a phosphor; and
a heat treatment product of an active carbon component.

8. A plasma display panel comprising:
a first substrate and a second substrate facing the first substrate;
a phosphor layer disposed in a discharge space between the first substrate and the second substrate;
a discharge electrode that applies a voltage to the discharge space so as to generate a discharge; and
a discharge gas loaded in the discharge space,
wherein the phosphor layer comprises a phosphor and a heat treatment product of an active carbon component.

9. The plasma display panel of claim 8, wherein the heat treatment product of the active carbon component is a product obtained by heat treating the active carbon component under an atmospheric condition at a temperature in a range of from 400° C. to 600° C.

10. The plasma display panel of claim 8, wherein the active carbon component includes an active carbon and an additional component, and wherein the heat treatment product of the active carbon component is derived from the additional component.

11. The plasma display panel of claim 8, wherein the heat treatment product of the active carbon component comprises at least one material selected from the group consisting of silica, alumina, Fe₂O₃, iron chloride (FeCl₃) and aluminum chloride (AlCl₃).

12. The plasma display panel of claim 8, wherein the amount of the heat treatment product of the active carbon component in the phosphor layer is in a range from 0.5 parts by weight to 15 parts by weight based on 100 parts by weight of the phosphor.

13. The plasma display panel of claim 8, wherein the phosphor comprises at least one phosphor selected from the group consisting of a green phosphor having a central wavelength of about 530 nm and a blue phosphor having a central wavelength in a range from 430 nm to 470 nm.

14. The plasma display panel of claim 8, wherein the phosphor layer is formed by heat treating a composition comprising a phosphor, a binder, a solvent; and an active carbon component.

15. A method of forming a phosphor layer on a surface, the method comprising:
applying the composition of claim 1 to the surface; and
heat treating the applied composition to form the phosphor layer.

16. A method of manufacturing a plasma display panel, the method comprising:
supplying the composition of claim 1 to surfaces defining a discharge space between a first substrate and a second substrate; and
heat treating the supplied composition to form a phosphor layer on the surfaces defining the discharge space.

17. The method of claim 16, wherein the heat treating of the supplied composition is performed at a temperature in a range from 400° C. to 600° C. under atmospheric conditions.

18. The method of claim 16, wherein the active carbon component comprises an active carbon and an additional component.

19. The method of claim 18, wherein the active carbon has a shape of spherical particles, amorphous particles, porous particles, fibers, horns, or plates.

20. The method of claim 18, wherein the additional component comprises at least one material selected from the group consisting of silicon, aluminum, iron, silica, alumina, Fe₂O₃, FeCl₃, AlCl₃ and chloride (Cl).
